(19) United States
(12) Patent Application Publication
(10) Pub. No.: US 2006/0277573 A1
(43) Pub. Date: Dec. 7, 2006

(54) Tuner apparatus and television receiver using same

(75) Inventor: Hiroshi Kinemura, Nara-shi (JP)

Correspondence Address: NIXON & VANDERHYE, PC, 901 NORTH GLEBE ROAD, 11TH FLOOR, ARLINGTON, VA, 22203, US

(73) Assignee: Sharp Kabushiki Kaisha, Osaka (JP)

(21) Appl. No.: 11/444,364

(22) Filed: Jun. 1, 2006

(30) Foreign Application Priority Data
Jun. 2, 2005 (JP) 2005-162164

(51) Int. Cl. H04N 5/445

(52) U.S. Cl. 725/39

(57) ABSTRACT

A tuner apparatus of the present invention is provided with select instruction conversion means in which not only a physical channel of an analog broadcast signal but also a physical channel of a digital broadcast signal is allocated for a virtual channel space built on external select instructions intended for selection of an analog broadcast signal so that the select instruction conversion means converts a given external select instruction, according to which virtual channel the external select instruction corresponds to, into either a first internal select instruction intended for selection of an analog broadcast signal or a second internal select instruction intended for selection of a digital broadcast signal. With this configuration, when both digital/analog broadcast signals broadcast mixedly in the same frequency band are received, even if an input select instruction is intended for selection of an analog broadcast signal, it is possible to also select a digital broadcast signal in an appropriate manner by using the input select instruction.

This nonprovisional application claims priority under 35 U.S.C. § 119(a) on Patent Application No. 2005-162164 filed in Japan on Jun. 2, 2005, the entire contents of which are hereby incorporated by reference.

### BACKGROUND OF THE INVENTION

1. Field of the Invention

The present invention relates to a tuner apparatus that receives both first and second broadcast signals broadcast mixedly in the same frequency band by different first and second types of broadcasting, and particularly to a television receiver that receives digital/analog television broadcasts.

2. Description of Related Art

In recent years, separate type television broadcast receivers in which a tuner apparatus and a monitor apparatus (for example, a liquid crystal display or a plasma display) are separately provided have been increasingly popular. Since such a separate type television broadcast receiver puts all the miscellaneous wiring connections such as antenna lines and conductors for AV (audio/visual) apparatuses in the tuner apparatus serving as an AV controller, it can reduce the number of conductors connected to the monitor apparatus. This makes it possible to offer a higher degree of flexibility in the layout of the monitor apparatus while keeping things neat and orderly around the monitor apparatus.

Conventionally, as shown in FIG. 6, many separate type analog terrestrial television broadcast receivers are structured as follows. A remote control reception portion B5 provided in a monitor apparatus B receives various user operations (including a selection operation) from a remote controller D, and a control portion B4 of the monitor apparatus B performs overall control of individual parts of the monitor apparatus B (for example, image quality adjustment by an image output portion B1, volume control by an audio output portion B2, and signal processing control by a reception signal processing portion B3) according to the user operations, and generates a select instruction “a” in accordance with a selection operation by the user and then transmits it to a tuner apparatus X.

On the other hand, the tuner apparatus X (a pre-processing portion called a front end) is built with an, analog tuner device X1 and an audio processing portion X2, and performs selection processing or audio processing for an analog terrestrial television broadcast signal received by an antenna C based on a select instruction “a” received from the control portion B4 of the monitor apparatus B.

Incidentally, with the recent introduction of a digital terrestrial television broadcast in parallel with the existing analog terrestrial television broadcast, as the tuner apparatus described above, there have been disclosed and proposed various types of tuner apparatuses that can receive digital/analog terrestrial television broadcast signals broadcast at 6 MHz separation (see, for example, JP-A-2003-309776).

As a conventional technology related to what has been described thus far, there has been disclosed and proposed a broadcast receiving apparatus that has the function of setting a virtual channel table (a so-called preset function) and can save the user the trouble of selecting a desired channel from multiple channels by managing a viewing history on a channel-by-channel basis and, at the time of setting new presets, weeding out a channel that is less likely to be selected from the presets (see, for example, JP-A-H9-116390).

Since the television broadcast receiver shown in FIG. 6, despite being a separate type television broadcast receiver in which the tuner apparatus X and the monitor apparatus B are separately provided, makes it possible to perform a selection operation for the monitor apparatus B just as in the case of a conventionally widely used built-in tuner television broadcast receiver, the user can operate it without sensing any discomfort and finds it very easy to use.

Additionally, by connecting the above-mentioned digital/analog broadcast-capable tuner apparatus in place of the existing tuner apparatus X, it becomes possible to view not only the existing analog terrestrial television broadcast but also a newly introduced digital terrestrial television broadcast.

However, in the conventional analog terrestrial television broadcast receiver, only received frequency information (in general, a prescaling value for a PLL (phase locked loop) circuit that controls an internal local oscillating signal of the analog tuner device X1) intended for selection of an analog terrestrial television broadcast signal is transmitted as a select instruction “a” from the monitor apparatus B to the tuner apparatus X; the conventional digital/analog broadcast-capable tuner apparatus needs to receive not only received frequency information intended for selection of an analog terrestrial television broadcast signal but also received frequency information intended for selection of a digital terrestrial television broadcast signal.

As a result, when the conventional digital/analog broadcast-capable tuner apparatus is connected to the monitor apparatus B in place of the analog broadcast-capable tuner apparatus X, the existing select instruction “a” is unfit for use in selection of a digital terrestrial television broadcast signal. The problem here is that it is impossible to perform selection operation of a digital terrestrial television broadcast signal via the monitor apparatus B unless the whole set of the television broadcast receiver including the monitor apparatus B is replaced. That is, selection operation of a digital terrestrial television broadcast signal needs to be performed directly for the newly installed tuner apparatus. This undesirably results in poor usability and places restrictions on the layout of the television broadcast receiver.

On the other hand, in the television broadcast receiver shown in FIG. 6, only limited information (e.g., a select instruction to the analog tuner device X1 or an audio switch instruction) is transmitted to the tuner apparatus X from the control portion B4. That is, with this television broadcast receiver, data (e.g., current time information or TV program listing information) other than image/audio transmitted as a broadcast wave cannot be fully exploited.

### SUMMARY OF THE INVENTION

In view of the conventionally experienced problems described above, it is an object of the present invention to provide a tuner apparatus and a television receiver using same that, when both first and second broadcast signals broadcast mixedly in the same frequency band by different first and second types of broadcasting are received, even if an input select instruction is intended for selection of a second broadcast signal, can also select a first broadcast signal in an appropriate manner by using the input select instruction.

To achieve the above object, according to the present invention, a tuner apparatus is provided with: first and second tuner portions that receive first and second broadcast signals, respectively, broadcast mixedly in the same frequency band by different first and second types of broadcasting; and select instruction conversion means in which not only a physical channel of a second broadcast signal but also a physical channel of a first broadcast signal is allocated for a virtual channel space built on external select instructions intended for selection of a second broadcast signal so that the select instruction conversion means converts a given external select instruction fed from outside the tuner apparatus, according to which virtual channel the external select instruction corresponds to, into either a first internal select instruction intended for selection of a first broadcast signal or a second internal select instruction intended for selection of a second broadcast signal. With this configuration, when both first and second broadcast signals are received, even if an input select instruction is intended for selection of a second broadcast signal, it is possible to also select a first broadcast signal in an appropriate manner by using the input select instruction.

### BRIEF DESCRIPTION OF THE DRAWINGS

FIG. 1 is a block diagram showing a first embodiment of the television broadcast receiver according to the present invention.

FIG. 2 is an illustration showing an example of a channel rearranging operation.

FIG. 3 is an illustration showing an example of a select instruction conversion table.

FIG. 4 is a block diagram showing an example of the image overlay means (the current time display means).

FIG. 5 is a block diagram showing a second embodiment of the television broadcast receiver according to the present invention.

FIG. 6 is a block diagram showing an example of a conventional television broadcast receiver.

### DETAILED DESCRIPTION OF PREFERRED EMBODIMENTS

Hereinafter, the present invention will be described in detail, taking up a case in which the present invention is applied to a television broadcast receiver that can receive both digital/analog television broadcasts.

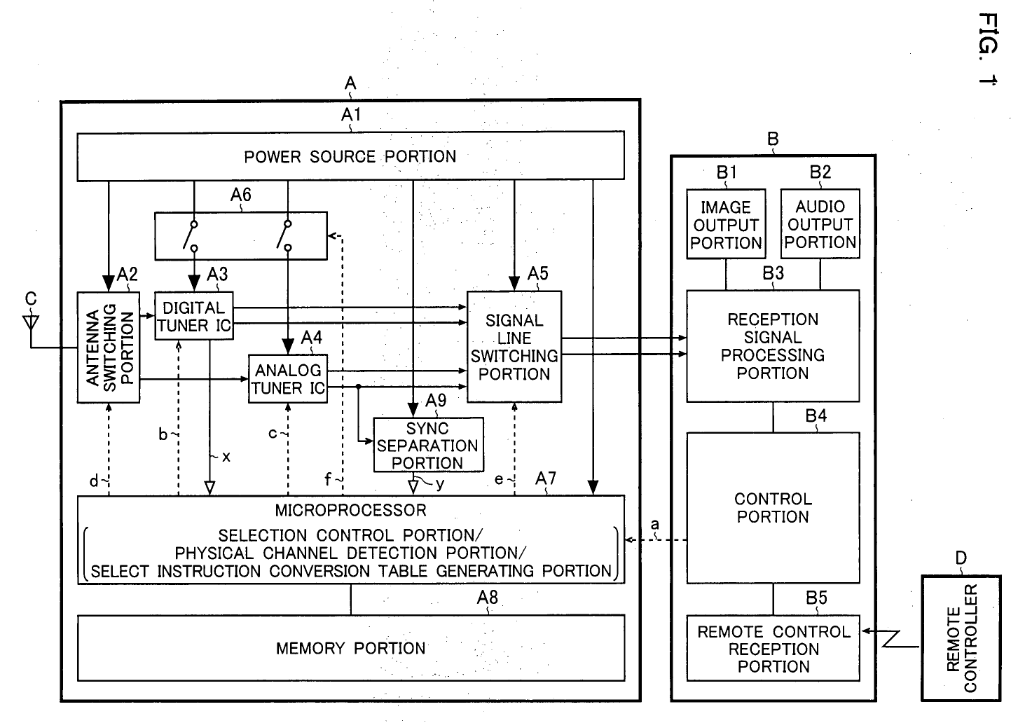

FIG. 1 is a block diagram showing a first embodiment of the television broadcast receiver according to the present invention. As shown in this figure, the television broadcast receiver of this embodiment is a separate type television broadcast receiver in which a tuner apparatus A and a monitor apparatus B (for example, a liquid crystal display or a plasma display) are separately provided. In this figure, the solid arrows indicate the transmission paths of a reception signal, and the broken arrows indicate the transmission paths of select instructions “a” to “c” and control instructions “d” to “f”. Moreover, the solid arrows each having a solid triangle as its head indicate the supply paths of drive power, and the solid arrows each having an outline triangle as its head indicate the transmission paths of reception state detection signals “x” and “y”.

The tuner apparatus A is built with a power source portion A1, an antenna switching portion A2, a digital tuner device A3, an analog tuner device A4, a signal line switching portion A5, a power supply control portion A6, a microprocessor A7, a memory portion A8, and a sync separation portion A9.

The power source portion A1 is a multiple output down-converter that generates, from a commercial alternating voltage (for example, AC 100 V), direct-current drive voltages (for example, DC 3 V, DC 5 V, and DC 24 V) for the relevant parts of the tuner apparatus.

The antenna switching portion A2 is means for selectively outputting, based on a control instruction “d” from the microprocessor A7, a reception signal received by an antenna C to one of the digital tuner device A3 and the analog tuner device A4.

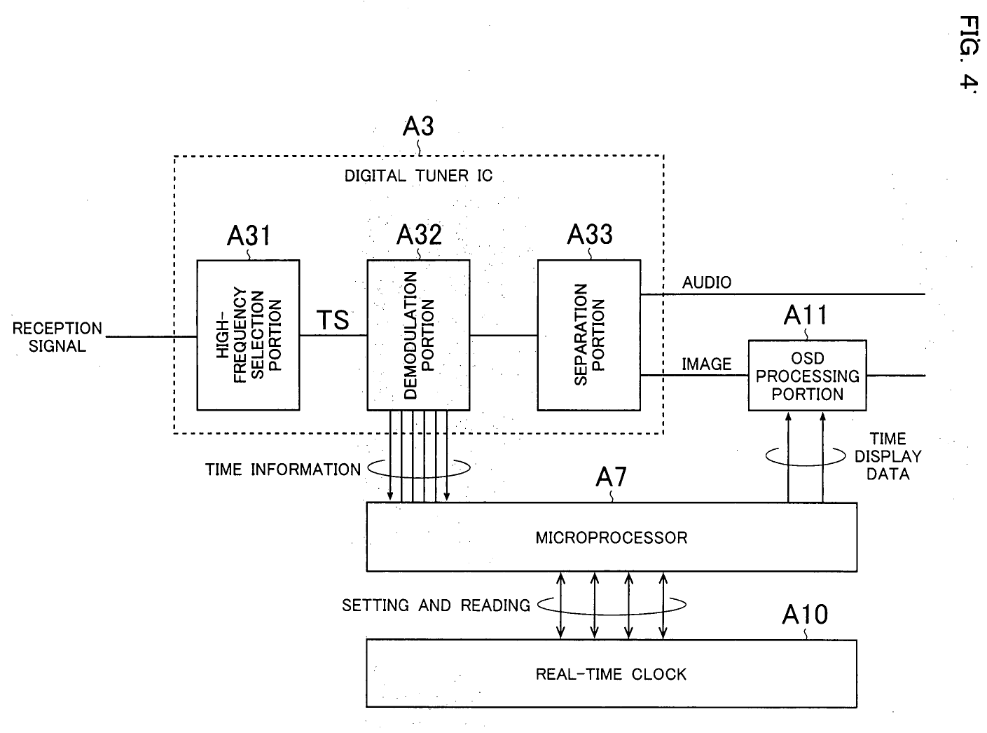

The digital tuner device A3 is means for performing, based on a first internal select instruction “b” (a select instruction intended for selection of a digital television broadcast signal) received from the microprocessor A7, predetermined signal processing for a reception signal received from the antenna switching portion A2. The specific internal circuit configuration thereof is as follows. As shown in FIG. 4, the digital tuner device A3 is formed by packaging, on a single chip IC, a high-frequency selection portion A31 that extracts a desired frequency band signal from the reception signal and then performs frequency conversion for the frequency band signal thus extracted to obtain an intermediate frequency signal TS, an OFDM (orthogonal frequency division multiplex) demodulation portion A32 that performs digital demodulation for the intermediate frequency signal TS obtained by the high-frequency selection portion A31, and a separation portion A33 that separates and converts the demodulated signal obtained by the OFDM demodulation portion A32 into an audio signal and an image signal. Additionally, the digital tuner device A3 has the function of generating an MPEG (Moving Picture Experts Group) lock signal as a reception state detection signal “x” of a digital television broadcast signal and then outputting the signal thus obtained to the microprocessor A7.

The analog tuner device A4 is means for performing, based on a second internal select instruction “c” (a select instruction intended for selection of an analog television broadcast signal) from the microprocessor A7, predetermined signal processing for a reception signal received from the antenna switching portion A2. The specific internal circuit configuration thereof is as follows. The analog tuner device A4 is formed by packaging, on a single chip IC, a tuner circuit portion that extracts a desired frequency band signal from the reception signal and then performs frequency conversion for the frequency band signal thus extracted to obtain an intermediate frequency signal, and an audio/image processing portion that separates and converts the intermediate frequency signal obtained by the tuner circuit portion into an audio signal and an image signal.

The signal line switching portion A5 is means for selectively outputting, based on a control instruction “e” from the microprocessor A7, an audio signal and an image signal obtained by one of the digital tuner device A3 and the analog tuner device A4 to a reception signal processing portion B3 of the monitor apparatus B.

The power supply control portion A6 is built with switch means that close/open electric power supply paths from the power source portion A1 to the digital tuner device A3 and to the analog tuner device A4, and is means for controlling, based on a control instruction “f” from the microprocessor A7, the electric power supply to the digital tuner device A3 and the analog tuner device A4. Specifically, the power supply control portion A6 controls the electric power supply to the digital/analog tuner devices A3 and A4 in such a way as to perform the electric power supply to a tuner device that is needed to be driven and interrupt the electric power supply to a tuner device that is not needed to be driven. With this configuration, in addition to suppressing unnecessary electric power consumption, it is possible to prevent electromagnetic interference (internal interference) between the digital/analog tuner devices A3 and A4.

The microprocessor A7 has, in addition to the function as an overall control portion that controls operations of individual parts of the tuner apparatus by transmitting the control instructions “d” to “f”, the function as a selection control portion that converts, based on a select instruction conversion table, which will be described later, an external select instruction “a” from the monitor apparatus B (a control portion B4) into a first internal select instruction “b” or a second internal select instruction “c” and then transmits the instruction thus converted to a corresponding one of the digital/analog tuner devices A3 and A4. The above-described external select instruction “a” is a prescaling value for a PLL circuit that controls an internal local oscillating signal of the analog tuner device A4, and the prescaling values are assigned one to each of 1 to 62 channels for an analog terrestrial television broadcast signal or C13 to C62 channels for a cable television broadcast signal. It is to be noted that the microprocessor A7 has other functions related to the present invention than specifically described above, which will be described in detail later.

The memory portion A8 is composed of a rewritable nonvolatile memory element such as a flash memory, and is means for storing a select instruction conversion table in which, for different virtual channels, the external select instructions “a” received from the monitor apparatus B are correlated with the first and second internal select instructions “b” and “c”. Such a table structure eliminates the need for newly setting a correlation between the external select instructions “a” and the first and second internal select instructions “b” and “c” at each startup, making it possible to perform select instruction conversion easily and quickly. In FIG. 1, the memory portion A8 is shown as being an independent block. It is to be understood, however, that the present invention may be configured by using a ROM (read-only memory), for example, provided in the microprocessor A7. Incidentally, the contents of the select instruction conversion table will be described in detail later.

The sync separation portion A9 is means for generating, as a reception state detection signal “y” of an analog television broadcast signal, a sync determination signal based on a horizontal/vertical synchronizing signal separated from an analog composite image signal, and then transmitting the signal thus generated to the microprocessor A7.

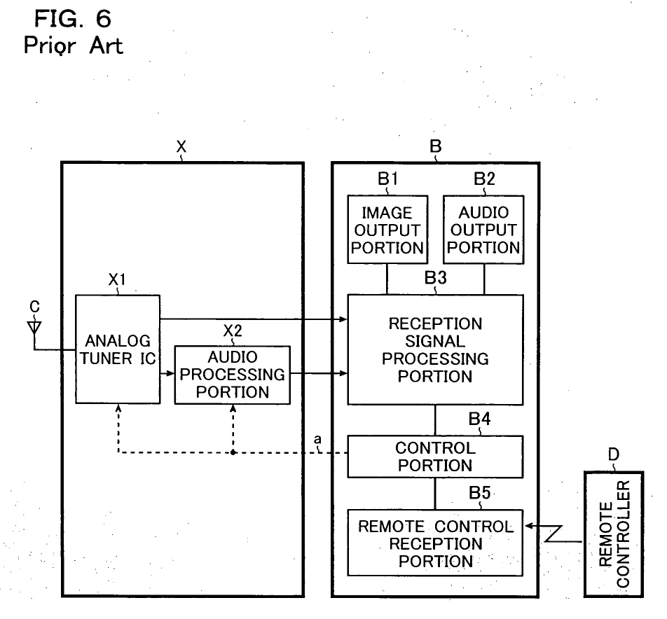

On the other hand, just as in the conventional example shown in FIG. 6 described earlier, the monitor apparatus B is structured as follows. A remote control reception portion B5 receives various user operations (including a selection operation) from a remote controller D, and the control portion B4 performs overall control of individual parts. of the monitor apparatus B (for example, image quality adjustment by an image output portion B1, volume control by an audio output portion B2, and signal processing control by a reception signal processing portion B3) according to the user operations, and generates an external select instruction “a” in accordance with a selection operation by the user and then transmits it to the tuner apparatus A. Note that, as the external select instruction “a” described above, only received frequency information intended for selection of an analog television broadcast signal is transmitted. That is, in the television broadcast receiver of this embodiment, the existing monitor apparatus B is used intact as the image/audio output means thereof.

With respect to the operations of the television broadcast receiver structured as described above, a virtual channel setting function (a so-called preset function) will be first described in detail.

When the tuner apparatus A is started up for the first time, for example, the microprocessor A7 initializes the preset virtual channels as follows. The microprocessor A7 searches for receivable physical channels by sweeping digital/analog television broadcast signals from one frequency to another, and detecting the reception states of individual physical channels and checking type of broadcasting (digital/analog) thereof. The above-described reception state detection is performed based on a reception state detection signal “x”, which is an MPEG lock signal, and a reception state detection signal “y”, which is a sync determination signal.

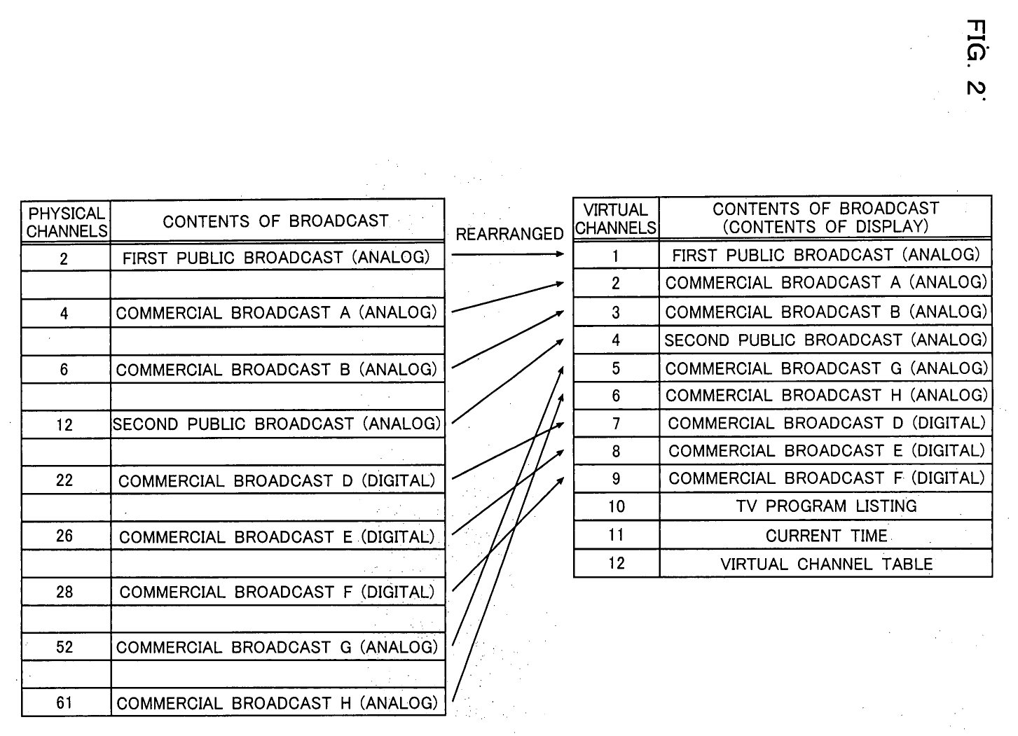

After searching for the receivable physical channels, as shown in FIG. 2, the microprocessor A7 generates the select instruction conversion table in such a way that the receivable physical channels thus searched are rearranged in a virtual channel space built on the external select instructions “a” in order of frequencies and/or according to a type of broadcasting. In the rearranging operation shown in FIG. 2, analog television broadcast signals are assigned to virtual channels 1 to 6 consecutively, with these analog television broadcast signals rearranged in order of frequencies, and digital television broadcast signals are assigned to virtual channels 7 to 9 consecutively, with these digital television broadcast signals rearranged in order of frequencies.

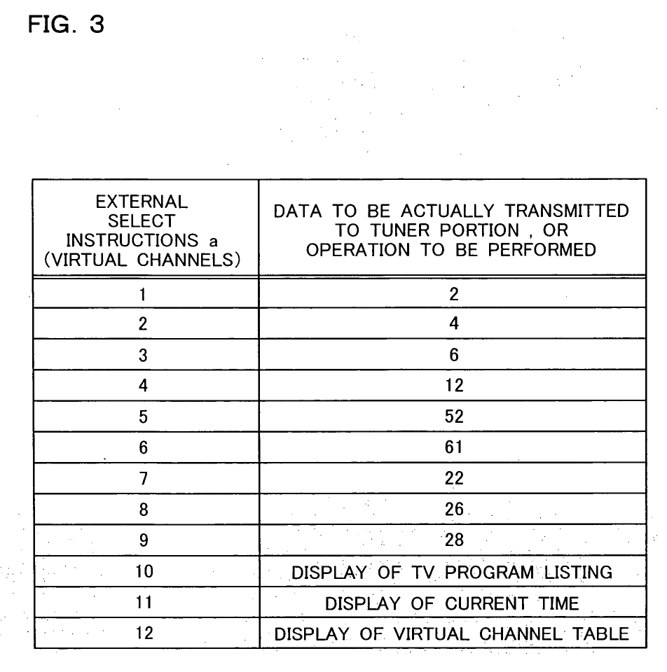

At this time, the select instruction conversion table is as shown in FIG. 3. For example, an external select instruction “a” representing a virtual channel “1” is correlated with a second internal select instruction “c” representing a physical channel “2” (analog first public broadcast), and an external select instruction “a” representing a virtual channel “7” is correlated with a first internal select instruction “b” representing a physical channel “22” (digital commercial broadcast D).

By doing such a physical channel rearranging operation, it is possible to establish a correlation between the external select instructions “a” and the first and second internal select instructions “b” and “c”, providing a channel arrangement that enhances user convenience without the need to perform complicated user operations.

Next, a channel selection operation based on the above-described select instruction conversion table will be described in detail. When an external select instruction “a” is transmitted from the monitor apparatus B to the tuner apparatus A, the microprocessor A7 performs reception processing for the external select instruction “a” and then performs select instruction conversion. Specifically, in the microprocessor A7, the external select instruction “a” from the monitor apparatus B is converted into a first internal select instruction “b” or a second internal select instruction “c” based on the select instruction conversion table stored in the memory portion A8, and then the internal select instruction thus obtained is transmitted to the digital tuner device A3 or the analog tuner device A4.

As described above, not only a physical channel of an analog television broadcast signal but also a physical channel of a digital television broadcast signal is allocated for a virtual channel space built on the external select instructions “a” by using the existing preset function. With this configuration, when both digital/analog television broadcast signals are received, even if an input external select instruction “a” is intended for selection of an analog television broadcast signal, it is possible to also select a digital television broadcast signal in an appropriate manner by using the input external select instruction “a”.

Thus, according to the present invention, it is possible to easily upgrade the existing television broadcast receiver set to a set that can receive a digital television broadcast signal without replacing the whole set of the existing television broadcast receiver. For example, when a digital television broadcast signal is desired to be received with an analog television broadcast receiver set (e.g., a bathroom television set) whose monitor apparatus B is fixed to the wall, it is possible to perform the upgrade of the analog television broadcast receiver set with extreme ease, because all that is needed is to replace the existing tuner apparatus with the tuner apparatus A of the present invention without changing the configuration or function of the monitor apparatus B.

Additionally, in the television broadcast receiver of this embodiment, an information display function performed by the image overlay means, which will be described later, is assigned to a predetermined virtual channel so that the microprocessor A7 converts an external select instruction “a” corresponding to the predetermined virtual channel into an information display instruction to be fed to the image overlay means. More specifically, as shown in FIG. 2, the microprocessor A7 assigns a display function of a TV program listing (an electronic program guide (EPG)) to a virtual channel “10”, a display function of a current time to a virtual channel “11”, and a display function of a virtual channel table (a table on the right side of FIG. 2) to a virtual channel “12”.

At this time, the above-described select instruction conversion table is as shown in FIG. 3. For example, an external select instruction “a” representing a virtual channel “10” is correlated with an information display instruction indicating the display of a TV program listing, and an external select instruction “a” representing a virtual channel “11” is correlated with an information display instruction indicating the display of a current time. Similarly, an external select instruction “a” representing a virtual channel “12” is correlated with an information display instruction indicating the display of a virtual channel table. Note that, in this embodiment, since part of the functions of the image overlay means, which will be described later, is realized by the microprocessor A7, the above-described information display instructions are issued to the microprocessor A7 itself.

In this way, the information display functions are assigned, allowing the user to display the contents (e.g., a TV program listing or a current time other than image/audio) of data broadcasting transmitted from a broadcaster along with a digital broadcast wave or a table of the preset virtual channels only by specifying a predetermined channel by using a selection function of the monitor apparatus B or the remote controller D without changing the configuration or function of the monitor apparatus B. The display function of a TV program listing or a virtual channel table is, in particular, a convenient function that answers the needs of the age of digital/analog multichannel broadcasts.

The image overlay means realizing the above-described information display functions will be described in detail with reference to FIG. 4, taking up a case in which a current time is displayed.

As shown in FIG. 4, the image overlay means of this embodiment is built with, in addition to the above-described microprocessor A7, a real-time clock A10 and an OSD (on-screen display) processing portion A11.

The demodulation portion A32 constituting the digital tuner device A3 extracts time information from the demodulated digital television broadcast signal, and then transmits it to the microprocessor A7. The microprocessor A7 feeds the time information thus received of the real-time clock A10, and performs an update of the current time data.

On the other hand, when an external select instruction “a” representing a virtual channel “11” is inputted to the microprocessor A7, the microprocessor A7 recognizes that the external select instruction “a” thus received is an information display instruction indicating the display of a current time based on the select instruction conversion table (see FIG. 3) stored in the memory portion A8, and then reads data from the real-time clock A10. The current time data thus read is transmitted to the OSD processing portion A11 as time display data.

Based on the time display data received from the microprocessor A7, the OSD processing portion A11 performs predetermined signal processing for an image signal received from the separation portion A33 constituting the digital tuner device A3, thereby overlaying an image representing a current time on the original image, and then outputs the resultant image signal to the monitor apparatus B.

With this configuration, it is always possible for the user to display a correct current time only by specifying a predetermined channel “11” by using a selection function of the monitor apparatus B or the remote controller D, providing the user with an added convenience.

The above-described embodiment deals with a display function of a current time. It is to be understood, however, a display function of a TV program listing or a display function of a virtual channel table can be realized in the same manner as described above by using the OSD processing portion A11.

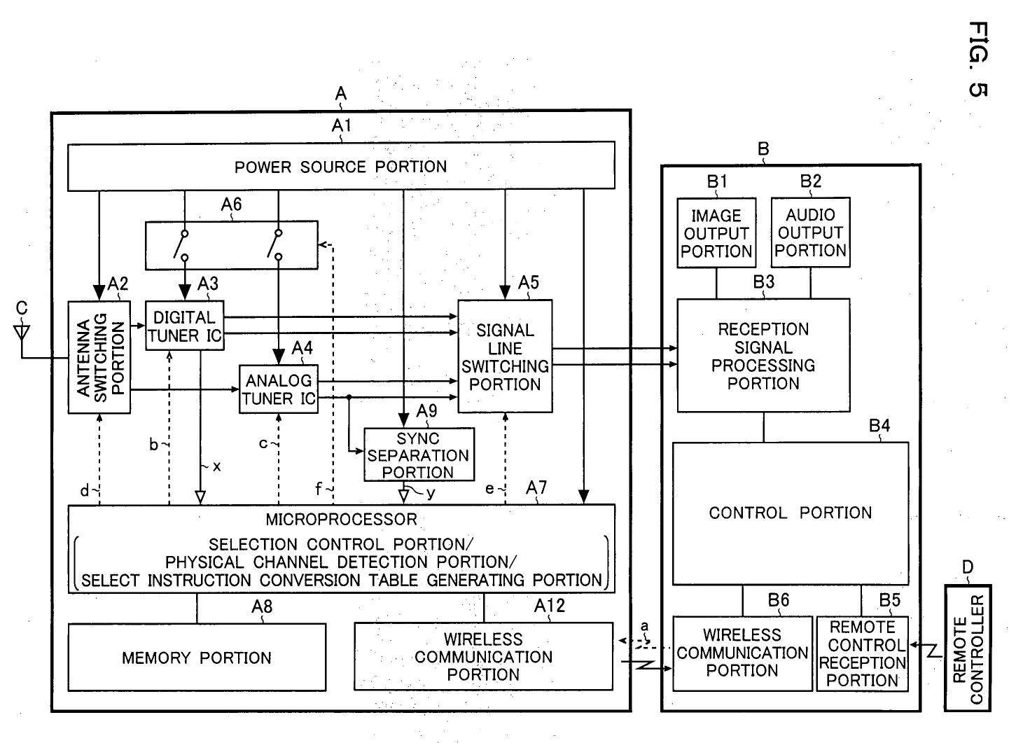

Next, a second embodiment of the television broadcast receiver according to the present invention will be described with reference to FIG. 5. The television broadcast receiver to this embodiment differs from that described in the first embodiment (see FIG. 1) only in that a tuner apparatus A and a monitor apparatus B are connected, not by a wired connection, but by a wireless connection. Therefore, in the following description, such members as are found also in the first embodiment will be identified with common reference characters, and only a feature of this embodiment will be specifically dealt with.

As shown in FIG. 5, the tuner apparatus A of this embodiment is additionally provided with a wireless communication portion A12 that wirelessly receives an external select instruction “a” from a wireless communication portion B6 of the monitor apparatus B, and wirelessly transmits an audio signal and an image signal obtained by a digital tuner device A3 or an analog tuner device A4 to the wireless communication portion B6 of the monitor apparatus B. Note that, as a method for wireless communication between the wireless communication portion A12 and the wireless communication portion B6, a spread spectrum communication system, for example, that uses the 2.4 GHz or 5 GHz band may be adopted. With this configuration, it is possible to build a separate type television broadcast receiver in which the tuner apparatus A and the monitor apparatus B are provided in a completely separate manner. This makes it possible to reduce the number of conductors connected to the monitor apparatus B by putting all the miscellaneous wiring connections such as antenna lines and conductors for AV apparatuses in the tuner apparatus A serving as an AV controller. This makes it possible to offer a higher degree of flexibility in the layout of the monitor apparatus B while keeping things neat and orderly around the monitor apparatus B.

The embodiments described above deal with cases where the present invention is applied to a television broadcast receiver that can receive digital/analog terrestrial television broadcasts. However, the present invention is not limited to this specific application, but may be applied to tuner apparatuses of any other types that receive both first and second broadcast signals broadcast mixedly in the same frequency band by different first and second types of broadcasting.

The embodiments described above deal with cases where the present invention is applied to a separate type television broadcast receiver. However, the present invention is not limited to this specific application, but may be applied to a built-in tuner television broadcast receiver that allows replacement of only a tuner apparatus.

The embodiments described above deal with configurations in which one digital input line and one analog input line are provided. However, the present invention is not limited to this specific configuration, but may be so configured that a plurality of digital input lines and a plurality of analog input lines are provided for making possible so-called switched diversity reception or combined diversity reception.

The embodiments described above deal with configurations in which preset virtual channels are automatically set. However, the present invention is not limited to this specific configuration, but may be so configured that the user is allowed to preset any virtual channels by using an operation portion (not shown) provided in the tuner apparatus A.

Obviously, many modifications and variations of the present invention are possible in light of the above teachings. It is therefore to be understood that within the scope of the appended claims, the invention may be practiced other than as specifically described.

The present invention is in particular suitable for use in a separate type television broadcast receiver in which a monitor apparatus and a tuner apparatus are separately provided.

What is claimed is:

1. A tuner apparatus comprising:
a first tuner portion for receiving a first broadcast signal broadcast by a first type of broadcasting;
a second tuner portion for receiving a second broadcast signal broadcast mixedly in a same frequency band as the first broadcast signal by a second type of broadcasting that is different from the first type of broadcasting; and
a select instruction conversion portion in which not only a physical channel of a second broadcast signal but also a physical channel of a first broadcast signal is allocated for a virtual channel space built on external select instructions intended for selection of a second broadcast signal so that the select instruction conversion portion converts a given external select instruction fed from outside the tuner apparatus, according to which virtual channel the external select instruction corresponds to, into either a first internal select instruction intended for selection of a first broadcast signal or a second internal select instruction intended for selection of a second broadcast signal.

2. The tuner apparatus of claim 1,
wherein the select instruction conversion portion includes
a memory portion that stores a select instruction conversion table in which, for different virtual channels, the external select instructions are correlated with the first and second internal select instructions, and
a selection control portion that converts the external select instruction to either the first or second internal select instruction based on the select instruction conversion table, and then transmits the first or second internal select instruction to a corresponding one of the first and second tuner portions.

3. The tuner apparatus of claim 2, further comprising:
a physical channel search portion for searching receivable physical channels with respect to the first and second broadcast signals; and
a select instruction conversion table generating portion for generating the select instruction conversion table so that the receivable physical channels are rearranged in the virtual channel space in order of frequencies and/or according to a type of broadcasting.

4. The tuner apparatus of claim 2, further comprising:
an image overlay portion for performing predetermined signal processing for an image signal. demodulated by the first and second tuner portions, and overlaying, on an original image, information on an arrangement in the virtual channel space and/or contents of data broadcasting and then outputting a resultant image.

5. The tuner apparatus of claim 4,
wherein the contents of data broadcasting are a TV program listing and/or a current time.

6. The tuner apparatus of claim 4,
wherein, in the select instruction conversion portion, an information display function performed by the image overlay portion is assigned to a predetermined virtual channel so that an external select instruction corresponding to the predetermined virtual channel is converted into an information display instruction to be fed to the image overlay portion.

7. The tuner apparatus of claim 1, further comprising:
a power supply control portion for controlling an electric power supply to the first and second tuner portions in such a way as to perform the electric power supply to a tuner portion that is needed to be driven and interrupt the electric power supply to a tuner portion that is not needed to be driven.

8. The tuner apparatus of claim 1, further comprising:
a wireless communication portion for wirelessly receiving the external select instruction from a monitor apparatus provided outside the tuner apparatus, and wirelessly transmitting, to the monitor apparatus, first and second broadcast signals obtained by the first and second tuner portions.

9. The tuner apparatus of claim 1,
wherein the first type of broadcasting is a digital broadcast, and the second type of broadcasting is an analog broadcast.

10. A television broadcast receiver comprising:
a tuner apparatus; and
a monitor apparatus that is provided separately from the tuner apparatus;
wherein the tuner apparatus includes
a first tuner portion for receiving a first broadcast signal broadcast by a first type of broadcasting,
a second tuner portion for receiving a second broadcast signal broadcast mixedly in a same frequency band as the first broadcast signal by a second type of broadcasting that is different from the first type of broadcasting, and
a select instruction conversion portion in which not only a physical channel of a second broadcast signal but also a physical channel of a first broadcast signal is allocated for a virtual channel space built on external select instructions intended for selection of a second broadcast signal so that the select instruction conversion portion converts a given external select instruction fed from outside the tuner apparatus, according to which virtual channel the external select instruction corresponds to, into either a first internal select instruction intended for selection of a first broadcast signal and a second internal select instruction intended for selection of a second broadcast signal.

11. The television broadcast receiver of claim 10,
wherein the select instruction conversion portion includes
a memory portion that stores a select instruction conversion table in which, for different virtual channels, the external select instructions are correlated with the first and second internal select instructions, and
a selection control portion that converts the external select instruction to either the first or second internal select instruction based on the select instruction conversion table, and then transmits the first or second internal select instruction to a corresponding one of the first and second tuner portions.

12. The television broadcast receiver of claim 11,
wherein the tuner apparatus further includes
a physical channel search portion for searching receivable physical channels with respect to the first and second broadcast signals; and
a select instruction conversion table generating portion for generating the select instruction conversion table so that the receivable physical channels are rearranged in the virtual channel space in order of frequencies and/or according to a type of broadcasting.

13. The television broadcast receiver of claim 11,
wherein the tuner apparatus further includes
an image overlay portion for performing predetermined signal processing for an image signal demodulated by the first and second tuner portions, and overlaying, on an original image, information on an arrangement in the virtual channel space and/or contents of data broadcasting and then outputting a resultant image.

14. The television broadcast receiver of claim 13,
wherein the contents of data broadcasting are a TV program listing and/or a current time.

15. The television broadcast receiver of claim 13,
wherein, in the select instruction conversion portion, an information display function performed by the image overlay portion is assigned to a predetermined virtual channel so that an external select instruction corresponding to the predetermined virtual channel is converted into an information display instruction to be fed to the image overlay portion.

16. The television broadcast receiver of claim 10,
wherein the tuner apparatus further includes
a power supply control portion for controlling an electric power supply to the first and second tuner portions in such a way as to perform the electric power supply to a tuner portion that is needed to be driven and interrupt the electric power supply to a tuner portion that is not needed to be driven.

17. The television broadcast receiver of claim 10,
wherein the tuner apparatus further includes
a wireless communication portion for wirelessly receiving the external select instruction from the monitor apparatus provided outside the tuner apparatus, and wirelessly transmitting, to the monitor apparatus, first and second broadcast signals obtained by the first and second tuner portions.

18. The television broadcast receiver of claim 10, wherein the first type of broadcasting is a digital broadcast, and the second type of broadcasting is an analog broadcast.
